(19) United States
(12) Patent Application Publication
(10) Pub. No.: US 2016/0367063 A1
(43) Pub. Date: Dec. 22, 2016

(54) System and Method of Brewing Beverages Using Geo-Location Based Brewing Parameters

(71) Applicant: BKON LLC, Newark, DE (US)

(72) Inventors: Dean J. Vastardis, Moorestown, NJ (US); Lou Vastardis, Moorestown, NJ (US)

(21) Appl. No.: 15/121,588

(22) PCT Filed: Feb. 27, 2015
(86) PCT No.: PCT/US15/18142

§ 371 Date: Aug. 25, 2016

Related U.S. Application Data
(60) Provisional application No. 61/945,443, filed on Feb. 27, 2014.

(51) Int. Cl. A47J 31/00; G06K 7/10; A47J 31/44; G05B 19/12

(52) U.S. Cl. CPC A47J 31/002; G05B 19/124; G06K 7/10861; A47J 31/4492

(57) ABSTRACT

A system for brewing a beverage dependent on the water characteristics of a brewing location is described. The system includes a brewing device, a packaged brewing material having a barcode with encoded information pertaining to at least one brewing parameter, and a database having stored thereon or having access to at least one brewing parameter associated with at least one characteristic of a water composition or TDS of the water used by the brewing device to brew a beverage. A method for providing beverage brewing parameters to a brewing location is also described. The method includes the steps of providing a brewing material to a brewing site, wherein the brewing material is associated with at least one brewing parameter, identifying the composition or TDS of water used to brew beverages at the brewing site, providing at least one brewing parameter dependent on the identified water composition or TDS, and brewing a beverage based on the at least one brewing parameter associated with the brewing material and the at least one brewing parameter dependent on the identified water composition or TDS.

### CROSS-REFERENCE TO RELATED APPLICATIONS

This application claims the benefit of priority to U.S. Provisional Application No. 61/945,443, filed Feb. 27, 2014, which is incorporated by reference herein in its entirety.

### BACKGROUND OF THE INVENTION

One of the key parameters in brewing a beverage, such as tea or coffee, is water composition and/or total dissolved solid (TDS). Such composition can be identified by the pH, alkalinity, harness, and TDS characteristics of the water used where the beverage is being brewed. The water quality TDS characteristics significantly impact the consistency and quality of the flavor profile of the resulting brewed beverage.

Because different locations pull their drinking water from difference sources, or because different locations may treat their drinking water differently, the water composition and/or TDS characteristics can vary dramatically depending on the exact location of the beverage being brewed. Unfortunately, this inevitably results in an inconsistent flavor of the beverage, depending on where the beverage was brewed.

Thus, there is a need in the art for a system and method to account for the differences in water composition and/or TDS characteristics to provide a consistently flavored brewed beverage. The present invention satisfies this need.

### SUMMARY OF THE INVENTION

A method for providing beverage brewing parameters to a brewing location is described. The method includes the steps of providing a brewing material to a brewing site, wherein the brewing material is associated with at least one brewing parameter, identifying the composition or TDS of water used to brew beverages at the brewing site, providing at least one brewing parameter dependent on the identified water composition or TDS, and brewing a beverage based on the at least one brewing parameter associated with the brewing material and the at least one brewing parameter dependent on the identified water composition or TDS. In one embodiment, the brewing parameter comprises vacuum pressure. In another embodiment, the brewing parameter comprises vacuum duration. In another embodiment, the brewing parameter is selected from the group consisting of water temperature, dispensing volume, steeping time, and separation of liquid from solids after brewing is complete. In another embodiment, the at least one brewing parameter associated with the brewing material is stored within a packaging barcode. In another embodiment, the at least one brewing parameter dependent on the identified water composition or TDS is provided over a communications network.

Another method for brewing a beverage dependent on the water characteristics of a brewing location is described. The method includes the steps of providing a brewing material to a brewing site, wherein the brewing material is associated with a plurality of complete brewing parameters for the desired beverage, uploading the plurality of complete brewing parameters to a brewing device, programming or selecting a water composition or TDS value corresponding to the water used to brew a beverage at the brewing location via the brewing device, identifying one of the plurality of complete brewing parameters that matches the programmed or selected water composition or TDS, and brewing the beverage according to the identified complete brewing parameter. In one embodiment, the brewing parameters comprise vacuum pressure. In another embodiment, the brewing parameters comprise vacuum duration. In another embodiment, the brewing parameters are selected from the group consisting of water temperature, dispensing volume, steeping time, and separation of liquid from solids after brewing is complete. In another embodiment, the plurality of brewing parameters associated with the brewing material is stored within a packaging barcode. In another embodiment, the number of complete brewing parameters is at least 3.

A system for brewing a beverage dependent on the water characteristics of a brewing location is described. The system includes a brewing device, a packaged brewing material having a barcode with encoded information pertaining to at least one brewing parameter, and a database having stored thereon or having access to at least one brewing parameter associated with at least one characteristic of a water composition or TDS of the water used by the brewing device to brew a beverage. In one embodiment, the barcode is a QR code. In another embodiment, the at least one brewing parameter comprises vacuum pressure. In another embodiment, the at least one brewing parameter comprises vacuum duration. In another embodiment, the at least one brewing parameter is selected from the group consisting of water temperature, dispensing volume, steeping time, and separation of liquid from solids after brewing is complete.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 is a schematic of a geo-location based brewing system involving a number of computing devices and brewing machine connected to each other via a communications network, according to an aspect of the present invention.

FIG. 2 is a chart depicting exemplary brewing parameters and variables for use within the system of the present invention.

FIG. 3 is a flowchart depicting exemplary steps to perform a first method of the present invention.

FIG. 4 is a flowchart depicting exemplary steps to perform a second method of the present invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in beverage brewing systems connected to a communications network. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods, materials or components similar or equivalent to those described herein can be used in the practice or testing of the present invention, the preferred methods, materials and components are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

The term “beverage” as used herein refers to any consumable liquid or drink, and can include, but is not limited to, flavored water, tea, coffee, juice, milk, soda, alcoholic liquids (i.e. liquids containing ethanol) and any other water or alcohol based consumable solution or combination thereof. The term “spirit” as used herein refers to distilled beverages or liquors, such as vodka or gin, and may also refer to undistilled fermented liquids, such as beer, wine, and cider. Beverages may also include any amount of solid phase particulates, such as infusion or brewing materials, as well as trapped or infused gaseous materials.

The terms “infusion material,” “brew material,” “brewing material,” “beverage making material” and the like are used interchangeably herein, and refer to any substance at least a portion of which is extracted into or is permeated by a consumable substance during a brewing or infusion step of the present invention. Examples of such a substance include, but are not limited to: coffee beans or grinds, tea leaves, cocoa, fruit, grains, herbs, spices, seasonings, botanicals, vegetables, wood chips, flavor additives, sweeteners, such as glucose, other sugars, artificial sweeteners, or any other material(s) suitable for consumption that can be used to impart a flavor to a consumable substance. Furthermore, the infusion materials of the present invention can be used fresh or dried (for instance, in the example of fruit, or another type of plant material, such as garlic); ground or whole (for instance, in the example of coffee beans); or, in general, can be processed or unprocessed prior to use in a brewing or infusion step of the present invention. There are no limitations to the size of infusion or brewing material components, in whole or particulate form, when used with the present invention. In one embodiment, the infusion material of the present invention can be a material that is readily dissolvable in the consumable substance to be infused, for example, salt or sugar, which are readily dissolvable in water or other liquids. Further, the infusion material can include non-solid materials. For example, the infusion material can be a liquid or syrup, such as “simple syrup,” or any type of juice or flavoring.

The terms “consumable substance,” “food product,” “consumable product,” “consumable material,” “infused liquid,” “liquid for infusion,” and the like are used interchangeably herein and refer to any material suitable for being infused with an infusion material. The consumable substance can be any edible material or mixture of edible materials, including, but not limited to oils, fats, vinegars, sauces, marinades, dressings, juices, meats, and the like. It is contemplated that the consumable substances useful for the infusion process of the present invention are not limited to any embodiments specifically noted herein, and can comprise any edible gas, liquid, or solid, or a mixture thereof.

Water composition may be defined as TDS alone or with a more detailed breakdown of alkalinity, pH, total hardness, turbidity, total chlorine, chloramine, iron, arsenic, and any other dissolved compounds. Measurements of such compounds can be combined to use index systems such as the Langelier index and or other existing or new index for water quality. Such indexes may be used as the identifying factor to activate the offsets or a single such as TDS or total hardness may serve as the identifying factor independently.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

Described embodiments of the platforms, engines, systems and methods contemplated herein are intended to be exemplary and not limiting. Reference will now be made in detail to various exemplary and illustrative embodiments of the present invention.

The present invention relates to beverage brewing systems and methods, and particularly to vacuum based brewing systems as described and illustrated in commonly owned U.S. Pat. Nos. 8,383,180 and 8,586,117, as well as commonly owned U.S. patent application Ser. Nos. 13/749,429; 14/083,014; and 14/499,924, the entire disclosures of which are each incorporated by reference herein in their entirety. While the present invention is primarily focused on use with vacuum based brewing systems, the present invention is not limited to such systems, and therefore may be suitable for use with any beverage brewing system that may send and receive data via a communications network, as understood by those skilled in the art.

As contemplated herein, the brewing process for a given beverage may include brewing parameters and variables that can be adjusted to produce an optimal and consistent beverage across a wide range of water composition, TDS specifications or any other characteristics for the water or other water-based liquid being used to brew the beverage, thereby solving a major obstacle within the consumer products beverage industry. For example, brewing parameters that are related to the water composition and/or TDS specification of water used at the brewing location may be incorporated into the final brewing protocol in order to offset the mineral composition of the actual water used in brewing, such that the optimal extraction and flavor are delivered consistently to the final brewed product, no matter where the product is geographically brewed.

Accordingly, the system allows for the delivery of specific brewing specifications (per beverage) to the on-site brewing equipment based on where the beverage is physically being brewed, taking into account the specific water composition and/or TDS characteristics for that specific location. In some embodiments, the water composition and/or TDS information is made available via a communications network, such as via a cloud based system that manages the association between a specific beverage product IDs, QR codes, geo-codes, water composition and/or TDS indexes, and brewing specifications between the on-site brewing equipment and one or more databases storing the desired information.

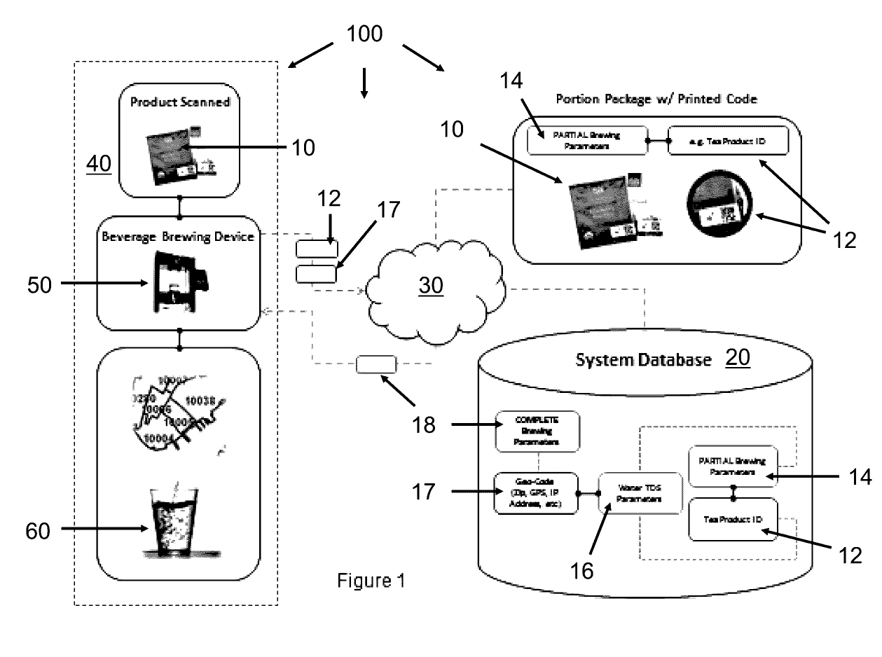

One exemplary embodiment of the system 100 is presented in FIG. 1. As shown in FIG. 1, the product may include a packaged brewing material 10 that is labeled with a product barcode 12, such as a QR code or any other information carrying identifier as would be understood by those skilled in the art. Encoded information 14 within the barcode 12 may include at least some, but not all, brewing parameters for that particular packaged product 10. This brewing parameter information 14, as well as additional brewing parameter information 16 and 18, may be stored in at least one database 20 that is accessible over a communications network 30. For example, database 20 may include, in addition to the partial brewing parameters 14 included with packaging 10, additional brewing parameters associated with various water TDS profiles or characteristics 16. Also stored in the same or other third-party database is a listing of water composition and/or TDS profiles or characteristics associated with a plurality of geographical locations 17, such as water TDS information associated with each zip code or with particular geographic coordinates, and/or by each water source feeding a particular geographical location. Further, database 20 may include a plurality of final or complete brewing parameters 18 for the packaged product 10 that are dependent on the particular water TDS characteristics selected.

After the packaged product 10 has been distributed to a particular location 40, the packaged product 10 is scanned, either by the beverage brewing device 50 or by a separate scanner, such that the beverage brewing device 50 or the operator of the beverage brewing device 50 can obtain the complete brewing parameters 18 for that particular product 10. Once scanned, the brewing device 50 or other component of the system 100 provides the geo-code 17 and identifies the water TDS profile or characteristics present at that specific brewing location 40 and adds the particular brewing parameters associated with the identified on-site brewing water TDS profile to the partial brewing parameters associated with the packaged product, and delivers the complete brewing parameters 18 to the beverage brewing device 50 via the communications network 30. With the complete brewing parameters 18 received, the beverage brewing device 50 brews the desired beverage 60 according to the completed brewing parameters 18 most desirable for brewing that particular packaged brewing material 10 with the specific water TDS used when brewing. Accordingly, the system 100 is able to select and deliver complete brewing parameters 18 that are specific and customized to the particular brewing material and the particular water composition and/or TDS found at the site where brewing occurs.

In an another embodiment, the packaged brewing material may be labeled with a QR code that is encoded with information that includes a plurality of complete brewing parameters for that particular packaged product suitable for a variety of water composition and/or TDS ranges. For example, if the water composition and/or TDS characteristics can be categorized into three different ranges, the encoded information will include three separate and complete brewing parameters to be used for each of the three water TDS ranges, respectively. In this embodiment, the system of the present invention may or may not require a communications network. For example, when the packaged brewing material is received at the brewing location, the QR code is scanned, such that the brewing device and/or operator of the brewing device can load the plurality of complete brewing parameters. Next, if the system utilizes a communications network, the brewing device or operator of the brewing device identify from either the system database or a third party database what the water TDS is for the water at the brewing location. Once the water TDS is identified, the brewing device or operator of the brewing device selects the particular brewing parameters corresponding to the water TDS, and the beverage is brewed. Alternatively, if the system does not utilize a communications network, the water TDS for that brewing location may already be known (or tested locally so that it is known), and the TDS value may be directly input into the brewing device. Then, the brewing device selects the particular brewing parameters for the input TDS value, and the beverage is brewed.

Accordingly, for this embodiment, the system of the present invention may perform the following steps: 1) the beverage material package is labeled with any type of barcode that can hold enough data to provide multiple complete brewing parameters or recipes per geo location; 2) the beverage material package is shipped to a brewing location and scanned, such that the brewing parameters are uploaded to the brewing device; 3) the TDS range is identified by the user via a system database, a local water report or measured via a TDS meter; 4) the water TDS is programmed or selected by the user via the brewing device; 5) the brewing device identifies the corresponding brewing parameter that matches the programmed water TDS; and 6) the beverage is brewed.

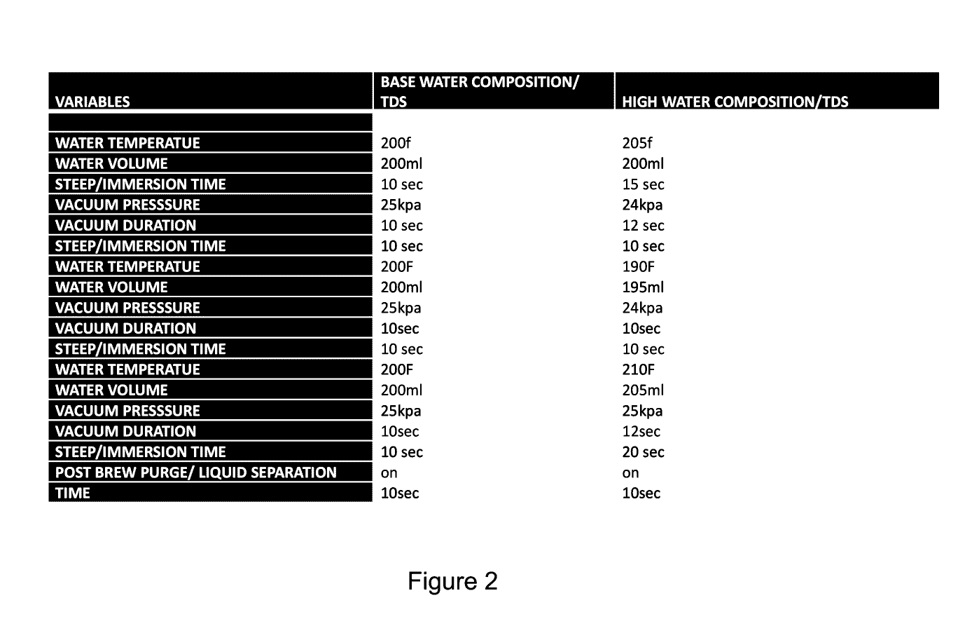

In certain embodiments and as outlined generally in FIG. 2, exemplary parameters for a specific beverage may include, without limitation, water temperature, dispensing volumes, steeping time, vacuum pressures, vacuum duration, and separation of liquid from solids after brewing is complete. Such parameters may be arranged in any combination and in any order as desired to produce the particular beverage.

For embodiments where the brewing equipment may be located in areas where the offsets cannot overcome the water composition/TDS, a geo-location system may be utilized to specify any necessary water filtration and/or treatment to bring the water characteristics within range for the system to be able to offset parameters, if needed. This may also serve as a means to protect the equipment from damaging minerals and water composition.

In order to offset higher TDS/composition water, a more aggressive use of brewing parameters may be implemented. In such embodiments, water temperature may be increased or decreased at specific times with different volumes in order to change the brewing behavior of the organic material. Additional or alternative changes in vacuum pressures, vacuum durations, and steep//immersion times may also be utilized, without limitation, to offset the water composition/TDS.

In other embodiments, the system and methods described herein may include water treatment equipment and components, such that the water may be physically adjusted to match at least one of the parameters used in a complete brewing parameter set of brewing instructions. Examples of treatment may include without limitation, the altering of water pH, the addition, removal or reduction of at least one mineral via filtration, and the like, as would be understood by those skilled in the art. This equipment and components may form part of the brewing device, or they may be separate from the brewing device.

Alternatively, the system may be applied to any beverage type, and to the infusion of alcohols, such as ethanol, into a beverage. For example, the percent of alcohol or “proof” of a given spirit may affect the rate of flavor extraction during an infusion process. Given that the percent ethanol can determine the rate at which the solvent is breaking down the flavor compounds from organic materials during and after a vacuum is applied, similar offsets for vacuum duration and vacuum pressures can be programmed based on the percent of alcohol in the base spirit. For example, a premium vodka may have about 70% alcohol, whereas a non-premium (well liquor) may have only 50%. The reduction in alcohol of the non-premium liquor may require longer, deeper or additional vacuum cycles to produce the same end result as the premium vodka. This percent of ethanol and the necessary offsets may be managed in a database and accessed via the UPC on the product in order adjust the parameters to create the targeted end result.

Similarly, whereas dairy may be used as a solvent, the percentage of fat in the dairy can affect the ability for the solvent to extract flavor compounds from the solid materials. Generally, the greater the percent of fat, the dairy may require longer, deeper or additional vacuum cycles to produce the same end result than a dairy with lower percent of fat.

Generally, the system of the present invention may operate on any computer platform connected via a communications network. As contemplated herein, any computing device as would be understood by those skilled in the art may be used with the system, provided they are network enabled or at least capable of connecting to a communications network. For example, the beverage brewing device may directly send and receive information to the system, or an operator of the beverage brewing device may send and receive information to the system via a computing device, such as a smartphone, tablet, laptop or other network enabled computing device.

The system may reside entirely on a single computing device, or may reside on a central server and run on any number of end-user devices via a communications network. The computing devices may include at least one processor, standard input and output devices, as well as all hardware and software typically found on computing devices for storing data and running programs, and for sending and receiving data over a network. If a central server is used, it may be one server or a combination of scalable servers, providing functionality as a network mainframe server, a web server, a mail server and central database server, all maintained and managed by an administrator or operator of the system. The computing device(s) may also be connected directly or via a network to remote databases, such as for additional storage backup, and to allow for the communication of files, email, software, and any other data format between two or more computing devices. There are no limitations to the number, type or connectivity of the databases utilized by the system of the present invention. The communications network can be a wide area network and may be any suitable networked system understood by those having ordinary skill in the art, such as, for example, an open, wide area network (e.g., the internet), an electronic network, an optical network, a wireless network, personal area networks such as Bluetooth, a physically secure network or virtual private network, and any combinations thereof. The communications network may also include any intermediate nodes, such as gateways, routers, bridges, internet service provider networks, public-switched telephone networks, proxy servers, firewalls, and the like, such that the communications network may be suitable for the transmission of information items and other data throughout the system.

The communications network may also use standard architecture and protocols as understood by those skilled in the art, such as, for example, a packet switched network for transporting information and packets in accordance with a standard transmission control protocol/Internet protocol (“TCP/IP”). Any of the computing devices may be communicatively connected into the communications network through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, all networking mechanisms utilized by smartphones, or any other mechanism as understood by those skilled in the art. Additionally, the system may utilize any conventional operating platform or combination of platforms (Windows, Mac OS, Unix, Linux, Android, etc.) and may utilize any conventional networking and communications software as would be understood by those skilled in the art.

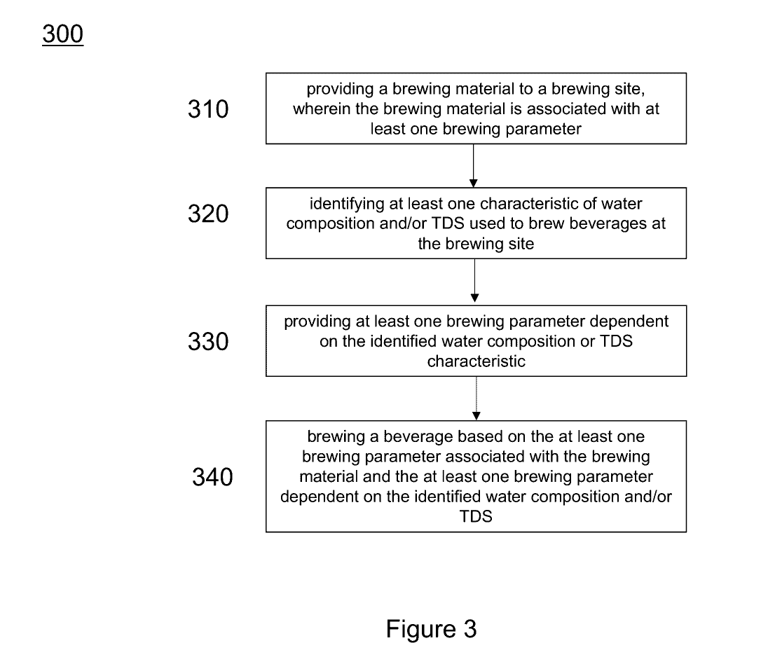

In a further embodiment, the present invention includes methods for providing beverage brewing parameters to a brewing location for brewing a beverage, as depicted in the flowchart of FIG. 3. In one embodiment, the method 300 includes steps for providing partial brewing parameters to a specific brewing location. At step 310, a brewing material is provided to a brewing site, wherein the brewing material is associated with at least one brewing parameter. At step 320, at least one characteristic of the composition and/or TDS of water used to brew beverages at the brewing site is identified. At step 330, at least one brewing parameter dependent on the at least one identified water composition and/or TDS characteristic is provided to the brewing site. Lastly, at step 340, a beverage is brewed based on the at least one brewing parameter associated with the brewing material and the at least one brewing parameter dependent on the identified water composition and/or TDS characteristic.

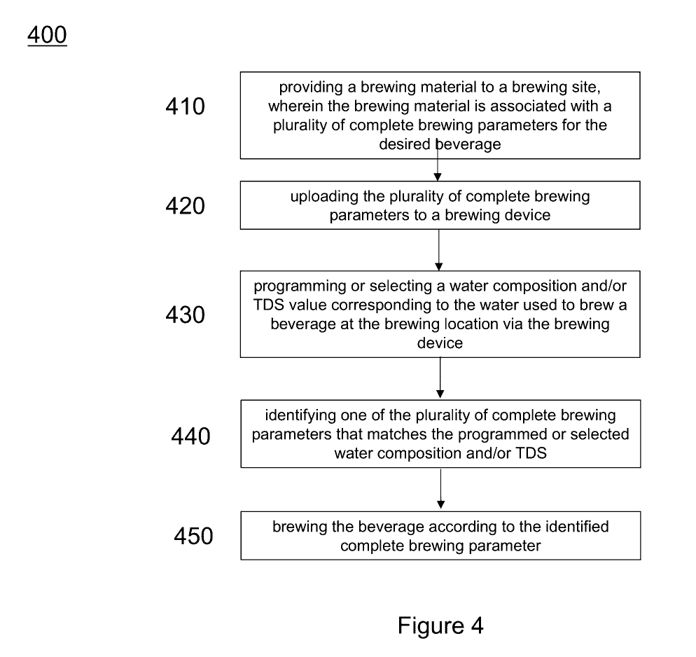

In a further embodiment, the present invention includes another method for providing beverage brewing parameters to a brewing location for brewing a beverage, as depicted in the flowchart of FIG. 4. In one embodiment, the method 400 includes steps for providing complete brewing parameters to a specific brewing location. At step 410, a brewing material is provided to a brewing site, wherein the brewing material is associated with a plurality of complete brewing parameters for the desired beverage. At step 420, the plurality of complete brewing parameters is uploaded to a brewing device. At step 430, a water composition and/or TDS value corresponding to the water used to brew a beverage at the brewing location is programmed or selected via the brewing device. At step 440, one of the plurality of complete brewing parameters that matches the programmed or selected water composition and/or TDS is identified. Lastly, at step 450, the beverage is brewed according to the identified complete brewing parameter.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A method for providing beverage brewing parameters to a brewing location, comprising:
providing a brewing material to a brewing site, wherein the brewing material is associated with at least one brewing parameter;
identifying the composition or TDS of water used to brew beverages at the brewing site;
providing at least one brewing parameter dependent on the identified water composition or TDS; and
brewing a beverage based on the at least one brewing parameter associated with the brewing material and the at least one brewing parameter dependent on the identified water composition or TDS.

2. The method of claim 1, wherein the brewing parameter comprises vacuum pressure.

3. The method of claim 1, wherein the brewing parameter comprises vacuum duration.

4. The method of claim 1, wherein the brewing parameter is selected from the group consisting of water temperature, dispensing volume, steeping time, and separation of liquid from solids after brewing is complete.

5. The method of claim 1, wherein the at least one brewing parameter associated with the brewing material is stored within a packaging barcode.

6. The method of claim 1, wherein the at least one brewing parameter dependent on the identified water composition or TDS is provided over a communications network.

7. A method for brewing a beverage dependent on the water characteristics of a brewing location, comprising:
providing a brewing material to a brewing site, wherein the brewing material is associated with a plurality of complete brewing parameters for the desired beverage;
uploading the plurality of complete brewing parameters to a brewing device;
programming or selecting a water composition or TDS value corresponding to the water used to brew a beverage at the brewing location via the brewing device;
identifying one of the plurality of complete brewing parameters that matches the programmed or selected water composition or TDS; and
brewing the beverage according to the identified complete brewing parameter.

8. The method of claim 7, wherein the brewing parameters comprise vacuum pressure.

9. The method of claim 7, wherein the brewing parameters comprise vacuum duration.

10. The method of claim 7, wherein the brewing parameters are selected from the group consisting of water temperature, dispensing volume, steeping time, and separation of liquid from solids after brewing is complete.

11. The method of claim 7, wherein the plurality of brewing parameters associated with the brewing material is stored within a packaging barcode.

12. The method of claim 7, wherein the number of complete brewing parameters is at least 3.

13. A system for brewing a beverage dependent on the water characteristics of a brewing location, comprising:
a brewing device;
a packaged brewing material having a barcode with encoded information pertaining to at least one brewing parameter; and
a database having stored thereon or having access to at least one brewing parameter associated with at least one characteristic of a water composition or TDS of the water used by the brewing device to brew a beverage.

14. The system of claim 13, wherein the barcode is a QR code.

15. The system of claim 13, wherein the at least one brewing parameter comprises vacuum pressure.

16. The system of claim 13, wherein the at least one brewing parameter comprises vacuum duration.

17. The system of claim 13, wherein the at least one brewing parameter is selected from the group consisting of water temperature, dispensing volume, steeping time, and separation of liquid from solids after brewing is complete.
